(19) United States
(12) Patent Application Publication
(10) Pub. No.: US 2025/0193038 A1
(43) Pub. Date: Jun. 12, 2025

(54) COORDINATION SUGGESTING APPARATUS, COORDINATION SUGGESTING SYSTEM, COORDINATION SUGGESTING METHOD AND RECORDING MEDIUM

(71) Applicant: Mitsubishi Electric Corporation, Tokyo (JP)

(72) Inventors: Yuji TAKEDA, Tokyo (JP); Kohei TAMANO, Tokyo (JP); Takayoshi TONOMURA, Tokyo (JP)

(21) Appl. No.: 18/843,098

(22) PCT Filed: Jul. 6, 2022
(86) PCT No.: PCT/JP2022/026873

§ 371 Date: Aug. 30, 2024

(30) Foreign Application Priority Data
Apr. 8, 2022 (JP) 2022-064358

(51) Int. Cl. H04L 12/28

(52) U.S. Cl. CPC H04L 12/2809; H04L 12/2823

(57) ABSTRACT

A server includes an influenced parameter collector to, when a setting parameter of a first device that is any one of all devices connected to a network built in a building is changed, collect, from each of devices that measure an influenced parameter among all the devices, values of the measured influenced parameter, the influenced parameter being a parameter that is influenced by change of the setting parameter of the first device, a data analyzer to analyze the collected values of the influenced parameter and detect a second device considered as having a correlation with the first device about a change trend of the values of the influenced parameter, and a coordination suggester to make a suggestion to a user about coordination between the first device and the second device when the second device is detected and coordinated operation between the first device and the second device is achievable.

### CROSS REFERENCE TO RELATED APPLICATION

This application is a U.S. national stage application of PCT/JP2022/026873 filed on Jul. 6, 2022, which is based on and claims the benefit of priority of the prior Japanese Patent Application No. 2022-064358 filed on Apr. 8, 2022, the entire contents of which are incorporated herein by reference.

### TECHNICAL FIELD

The present disclosure relates to a coordination suggesting apparatus, a coordination suggesting system, a coordination suggesting method, and a program.

### BACKGROUND

A management system for managing operation and the like of each of a plurality of devices installed in a house by a home controller installed in the house is known, in which the home controller and the plurality of devices are connected to a network in the house (for example, Patent Literature 1). A technique that allows coordinated operation between different devices in such a system is also known.

### PATENT LITERATURE

Patent Literature 1: Japanese Patent No. 6331111

For such coordinated operation between the different devices, the devices concerned are usually required to be installed in the same place (i.e., in the same room). In this case, a user needs to pre-register, with the home controller, installation locations of the devices that are to operate in a coordinated manner and this would require additional labor.

### SUMMARY

The present disclosure is made to solve the aforementioned problems, and an objective of the present disclosure is to provide a coordination suggesting apparatus, a coordination suggesting system, a coordination suggesting method, and a program capable of providing device coordination services without adding such labor to a user.

To achieve the above objective, a coordination suggesting apparatus according to the present disclosure includes
influenced parameter collecting means for, when a setting parameter of a first device that is any one of all devices connected to a network built in a building is changed, collecting, from each of devices that measure an influenced parameter among all the devices connected to the network, values of the measured influenced parameter, the influenced parameter being a parameter that is influenced by change of the setting parameter of the first device;
data analysis means for analyzing the collected values of the influenced parameter and detecting a second device regarded as having a correlation with the first device about a change trend of the values of the influenced parameter; and
coordination suggesting means for making a suggestion to a user about coordination between the first device and the second device when the second device is detected and coordinated operation between the first device and the second device is achievable.

According to the present disclosure, providing device coordination services without adding labor to the user can be achieved.

### BRIEF DESCRIPTION OF DRAWINGS

FIG. 1 is a diagram illustrating an overall configuration of a device management system in an embodiment;

FIG. 2 is a block diagram illustrating a hardware configuration of a server in the embodiment;

FIG. 3 is a block diagram illustrating a hardware configuration of a user terminal in the embodiment;

FIG. 4 is a block diagram illustrating a functional configuration of the server in the embodiment;

FIG. 5 is a diagram illustrating an example of parameter relationship information in the embodiment;

FIG. 6 is a diagram for explaining analysis of an influenced parameter in the embodiment;

FIG. 7 is a diagram illustrating an example of installation location information in the embodiment;

FIG. 8 is a diagram illustrating an example of the installation location information in the embodiment;

FIG. 9 is a diagram illustrating an example of the installation location information in the embodiment;

FIG. 10 is a diagram illustrating an example of a coordination function list in the embodiment;

FIG. 11 is a diagram illustrating an example of a coordination suggesting screen in the embodiment;

FIG. 12 is a flowchart illustrating steps of coordination suggesting processing in the embodiment;

FIG. 13 is a diagram illustrating an overall configuration of a device management system in a modified example of the embodiment;

FIG. 14 is a block diagram illustrating a hardware configuration of a home controller in the modified example of the embodiment;

FIG. 15 is a diagram illustrating an example of a user I/F screen in the modified example of the embodiment; and

FIG. 16 is a diagram illustrating an example of the user I/F screen in the modified example of the embodiment.

### DETAILED DESCRIPTION

Embodiments of the present disclosure are described below in detail with reference to the drawings.

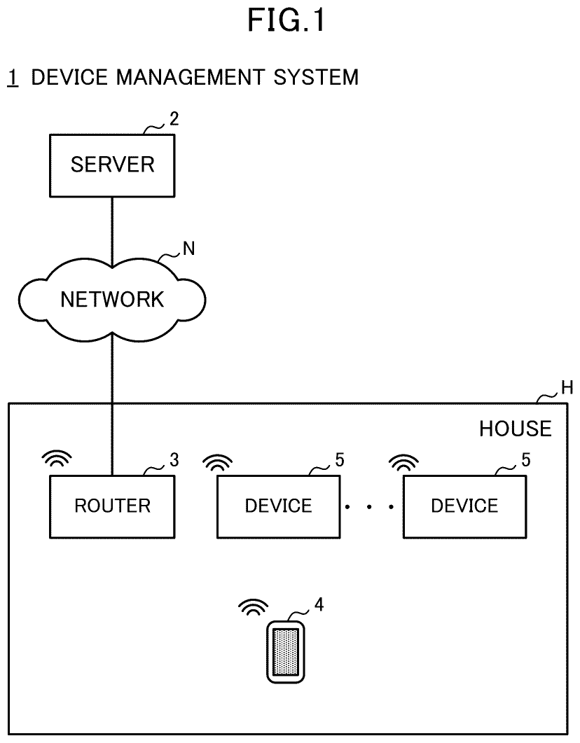

FIG. 1 is a diagram illustrating an overall configuration of a device management system 1 in an embodiment. The device management system 1 is an example of a coordination suggesting system according to the present disclosure. The device management system 1 is a system that enables a user to easily manage one or more devices 5 installed in a house H of the user. The house His an example of buildings according to the present disclosure. As illustrated in FIG. 1, the device management system 1 includes a server 2, a router 3, and a user terminal 4.

### Server 2

The server 2 is an example of a coordination suggesting apparatus according to the present disclosure. The server 2 is a so-called cloud server installed and operated by a manufacturer, a seller, or the like of the device 5. The server 2 provides the user with device coordination services for coordinated operations of the devices 5.

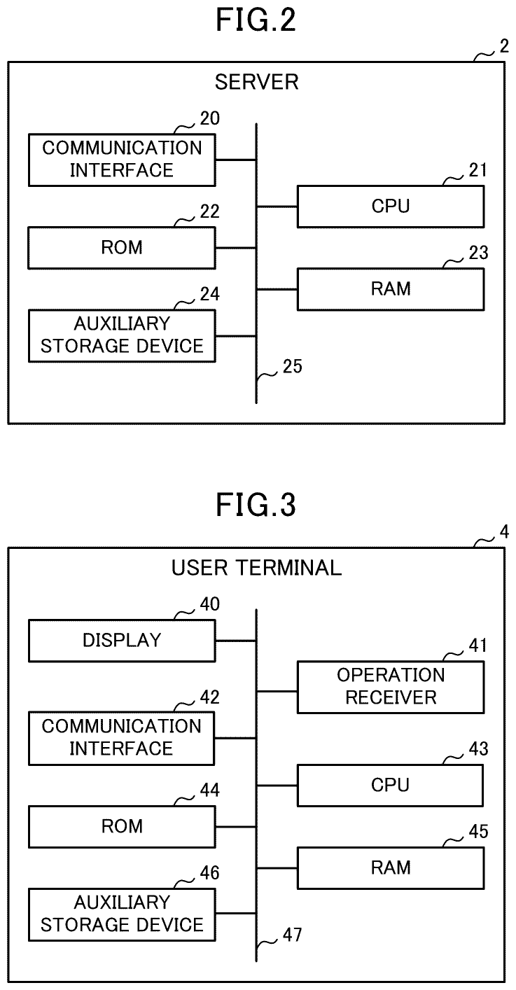

As illustrated in FIG. 2, the server 2 includes, as a hardware configuration, a communication interface 20, a central processing unit (CPU) 21, a read only memory (ROM) 22, a random access memory (RAM) 23, and an auxiliary storage device 24. These components are connected to one another via a bus 25. The communication interface 20 is hardware to communicate with another device through a network N that is a wide area network such as the Internet and is, for example, an Ethernet (registered trademark)-based interface.

The CPU 21 performs overall control over the server 2. Details of functions of the server 2 achieved by the CPU 21 are described later. The ROM 22 stores multiple pieces of firmware and data for use in execution of these pieces of firmware. The RAM 23 is used as a working area for the CPU 21.

The auxiliary storage device 24 includes a readable and writable non-volatile semiconductor memory, a hard disk drive (HDD), or the like. The readable and writable non-volatile semiconductor memory is, for example, an electrically erasable programmable ROM (EEPROM), a flash memory, or the like. The auxiliary storage device 24 stores a device coordination program that is a program for achieving the device coordination services and data for use in execution of the device coordination program.

The server 2 can, by communication via the network N, obtain from another server the device coordination program or an update program for updating the device coordination program. Also, these programs can be stored and distributed in a computer-readable recording medium, such as a compact disc read only memory (CD-ROM), a digital versatile disc (DVD), a magneto-optical disc, a universal serial bus (USB) memory, an HDD, a solid state drive (SSD), a memory card, or the like. The server 2 can also read out and acquire, upon direct or indirect attachment thereto of such recording medium, the device coordination program or the update program from the recording medium.

### Router 3

The router 3 is a wireless local area network (LAN), such as Wi-Fi (registered trademark) router, installed in the house H. The wireless LAN (hereinafter referred to as a home network) is built with the router 3 in the house H. The home network is an example of a network according to the present disclosure. The router 3 may be a wired LAN router. Alternatively, the router 3 may have both wireless and wired LAN functions and may be configured to perform wireless communication with one device 5 and wired communication with another device 5.

### User Terminal 4

The user terminal 4 is an example of a terminal device according to the present disclosure. The user terminal 4 is an electronic device carried by a user and is a smart device, such as a smartphone or a tablet terminal. As illustrated in FIG. 3, the user terminal 4 includes a display 40, an operation receiver 41, a communication interface 42, a CPU 43, a ROM 44, a RAM 45, and an auxiliary storage device 46. These components are connected to one another via a bus 47.

The display 40 includes a display device, such as a liquid crystal display, an organic electro luminescence (EL) display, or the like. The display 40 displays, under control of the CPU 43, various types of screens and the like in accordance with a user operation. The operation receiver 41 includes one or more input devices, such as a push-button, a touch panel, and a touch pad, receives an input operation from the user, and sends to the CPU 43 a signal corresponding to the received operation.

The communication interface 42 includes hardware for wireless LAN to connect to the home network or to an outdoor access point, and hardware for mobile data communication.

The CPU 43 performs overall control over the user terminal 4. The ROM 44 stores multiple pieces of firmware and data for use in execution of these pieces of firmware. The RAM 45 is used as a working area for the CPU 43.

The auxiliary storage device 46 includes a readable and writable non-volatile semiconductor memory, such as an EEPROM, a flash memory, or the like. The auxiliary storage device 46 stores various types of programs including an application program (hereinafter referred to as a “device operation application”) to enable a user to perform various operations on the device 5 or various settings on the server 2, and data for use in execution of these programs.

The user terminal 4 can, by communication via the network N, obtain from the server 2 or another server the device operation application or an update program for updating the device operation application. These programs can be distributed by storage in a computer-readable recording medium, such as a CD-ROM, a DVD, a magneto-optical disc, a USB memory, an HDD, an SSD, and a memory card. The user terminal 4 can also read out and acquire, upon direct or indirect attachment thereto of such recording medium, the device operation application or the update program from the recording medium.

### Device 5

The device 5 is an example of a device according to the present disclosure. The device 5 is a home appliance referred to as a so-called Internet of Things (IoT) device, an information home appliance, an Internet home appliance, or a smart home appliance. The device 5 is, for example, an air conditioner, an air-conditioning ventilation fan, an air purifier, a lighting device, a television, or the like. The device 5 includes hardware to connect to the home network. The device 5 may be configured to connect to the home network via a non-illustrated external communication adapter. Also, the device 5 is not limited to a home appliance, and may be, for example, a sensor, such as a temperature sensor, a humidity sensor, or a CO₂ sensor.

The device 5 performs operations corresponding to a user's operation using the device operation application, a user's operation using a dedicated remote controller of the device 5, an operation using an operation panel included in the device 5, and the like. When the setting parameter of the device 5 is changed by the user's operation, the device 5 sends to the server 2 a notification (hereinafter referred to as a “parameter change notification”) indicating change of the setting parameter.

The setting parameter is a parameter relating to the operation of the device 5 and settable by the user to the device 5. For example, when the device 5 is an air conditioner, the setting parameter includes a setting temperature, an air volume, and the like. When the device 5 is an air-conditioning ventilation fan, the setting parameter includes the air volume and the like, when the device 5 is an air purifier, the setting parameter includes a cleanliness factor and the like, and when the device 5 is a lighting device, the setting parameter includes an illumination intensity and the like.

Upon reception of a request from the server 2 to send a specified influenced parameter, the device 5 sends to the server 2 influenced parameter information including its own device ID, a current time, a value of the influenced parameter measured by the device 5 itself. The device identifier (ID) is information for uniquely identifying each device 5, and for example, a serial number (also called a manufacturer's serial number or a serial code).

The influenced parameter is an environmental condition that is influenced by change of the setting parameter of the device 5. For example, when any of the devices 5 is an air conditioner and the setting temperature of the air conditioner is changed by the user, the room temperature of a room where the air conditioner is installed and a temperature of air (hereinafter referred to as an “discharged air temperature”) discharged from the room to the outdoor are influenced by change of the setting temperature. In this case, the room temperature and the discharged air temperature are both influenced parameters relative to the setting temperature (that is, setting parameter). The server 2 stores in advance information indicating a relationship between the setting parameter and the influenced parameter.

Upon reception of a control command relating to a coordination function sent from the server 2, the device 5 operates in accordance with the control command. The coordination function is a function with which, providing that devices 5 of certain different models are installed in the same place (that is, in the same room), one device 5 is automatically controlled in accordance with an operation state of another device 5. Details of the coordination function are described later.

### Functional Configuration of Server 2

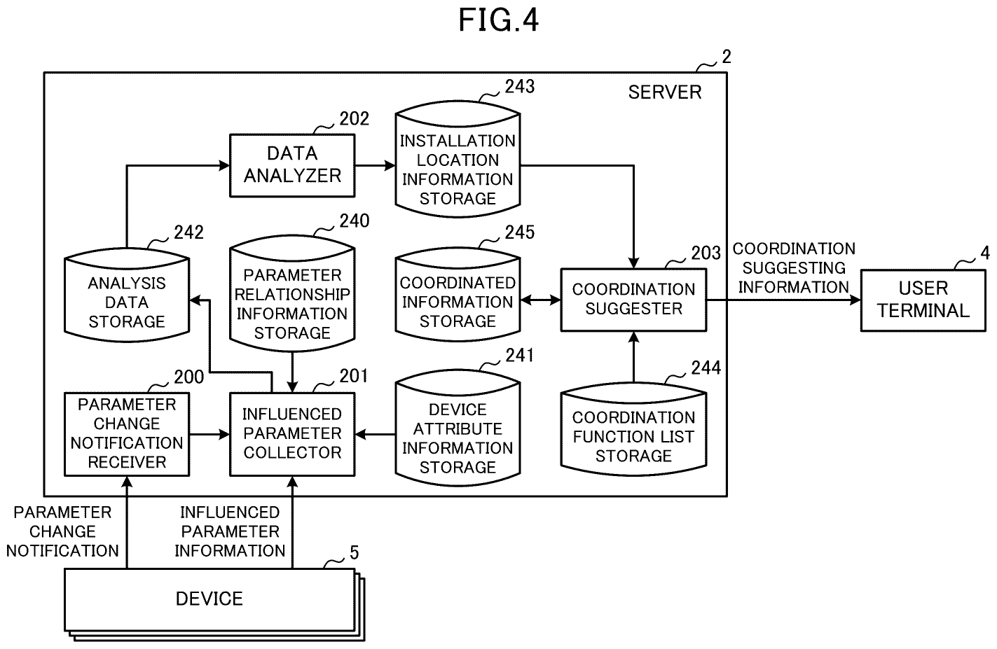

FIG. 4 is a block diagram illustrating a functional configuration of the server 2. As illustrated in FIG. 4, the server 2 includes, as characteristic functions according to the present disclosure, a parameter change notification receiver 200, an influenced parameter collector 201, a data analyzer 202, and a coordination suggester 203. These functions are achieved by the CPU 21 executing the aforementioned device coordination program stored in the auxiliary storage device 24. In addition to the above, the server 2 has functions, such as a function that enables a user in the outdoor to monitor and control the device 5 using the device operation application, and a function of executing control based on the coordination function for the devices 5 that are set to be coordinated, that is, the devices 5 for which coordination setting is made, but description of these functions is omitted.

The parameter change notification receiver 200 receives the aforementioned parameter change notification sent from any of the devices 5. The parameter change notification receiver 200 notifies the influenced parameter collector 201 of the setting parameter indicated by the received parameter change notification.

The influenced parameter collector 201 is an example of influenced parameter collecting means according to the present disclosure. When the parameter change notification sent from any of the devices 5 in the house H is received by the parameter change notification receiver 200, the influenced parameter collector 201 collects, from each of devices 5 that measure an influenced parameter corresponding to the setting parameter indicated by the parameter change notification among all the devices 5 connected to the home network of the house H, values of the measured influenced parameter.

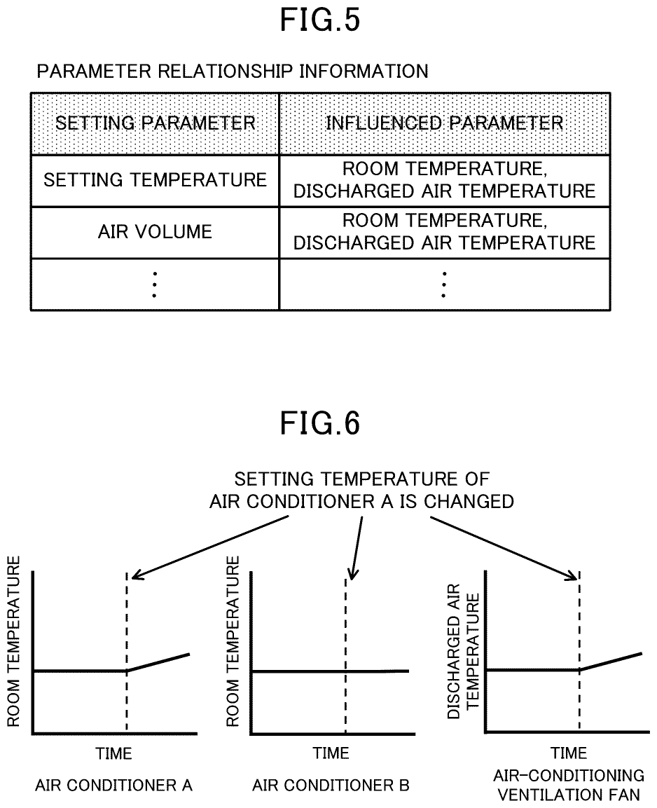

Specifically, the influenced parameter collector 201 refers to the parameter relationship information stored in a parameter relationship information storage 240 and determines the influenced parameter corresponding to the setting parameter. The parameter relationship information storage 240 is a memory area provided by the auxiliary storage device 24 and an example of parameter relationship information storage means according to the present disclosure. As illustrated in FIG. 5, the parameter relationship information is information indicating a relationship between the setting parameter and the influenced parameter.

The influenced parameter collector 201 refers to device attribute information stored in a device attribute information storage 241 and selects a device 5 that measures the determined influenced parameter. The device attribute information storage 241 is a memory area provided by the auxiliary storage device 24. The device attribute information is information indicating attribute information of each device 5 installed in the house H of each user. The attribute information includes the device ID, a type name, a model name, an environmental condition of a measurement target, and the like. The influenced parameter collector 201 refers to the device attribute information and selects all the devices 5 that measure the influenced parameter corresponding to the setting parameter. Then, the influenced parameter collector 201 periodically (e.g., every minute) requests each of the selected devices 5 to send the corresponding influenced parameter until a predetermined parameter collection time elapses.

Each device 5 having received the request sends to the server 2 the influenced parameter information including its own device ID, the current time, the values of the influenced parameter measured by the device 5 itself, as described above. The influenced parameter collector 201 receives and obtains the influenced parameter information sent from each device 5 and saves the obtained influenced parameter information in the analysis data storage 242, with the information sorted chronologically for each device 5. The analysis data storage 242 is a memory area provided by the auxiliary storage device 24.

The data analyzer 202 is an example of data analysis means according to the present disclosure. Upon completion of collection of the values of the influenced parameter by the influenced parameter collector 201 (that is, after a lapse of the parameter collection time from start of collection of the values of the influenced parameter), the data analyzer 202 analyzes a history of the influenced parameter information of each device 5 saved in the analysis data storage 242. Then, the data analyzer 202 detects a device 5 (an example of a second device according to the present disclosure) regarded as having a correlation about a change trend in the values of the influenced parameter with a device 5 (an example of a first device according to the present disclosure) whose setting parameter is changed. When there is a device 5 regarded as having a correlation about the change trend in the values of the influenced parameter with the device 5 whose setting parameter is changed, the data analyzer 202 determines that those devices 5 are installed in the same room.

For example, it is assumed that the setting temperature of an air conditioner A is increased, the influenced parameter collector 201 collects values of the influenced parameters from three devices 5 that are the air conditioner A, an air conditioner B, and an air-conditioning ventilation fan, and the values of the influenced parameter of each device 5 change as illustrated in FIG. 6. As illustrated in FIG. 6, the air conditioner B shows no change in the measured room temperature before and after change of the setting temperature of the air conditioner A. By contrast, the room temperature measured by the air conditioner A and the discharged air temperature measured by the air-conditioning ventilation fan both increase after the setting temperature of the air conditioner A is increased, which shows a positive correlation. Thus, the data analyzer 202 determines that the air conditioner A and the air-conditioning ventilation fan are installed in the same room.

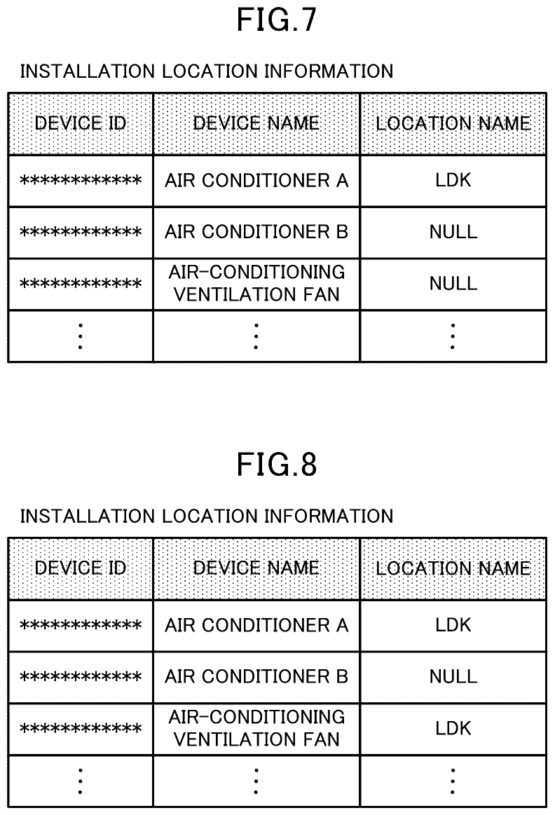

When the data analyzer 202 detects another device 5 installed in the same room as the device 5 whose setting parameter is changed, the data analyzer 202 updates based on the detection result the installation location information stored in an installation location information storage 243. Specifically, the data analyzer 202 updates the installation location information so that the installation locations of those devices 5 are the same. The installation location information storage 243 is a memory area provided by the auxiliary storage device 24 and is an example of installation location information storing means according to the present disclosure. The installation location information is information indicating the installation location of each device 5 installed in the house H of each user. As illustrated in FIG. 7, the installation location information includes the device ID, a device name, a location name, and the like.

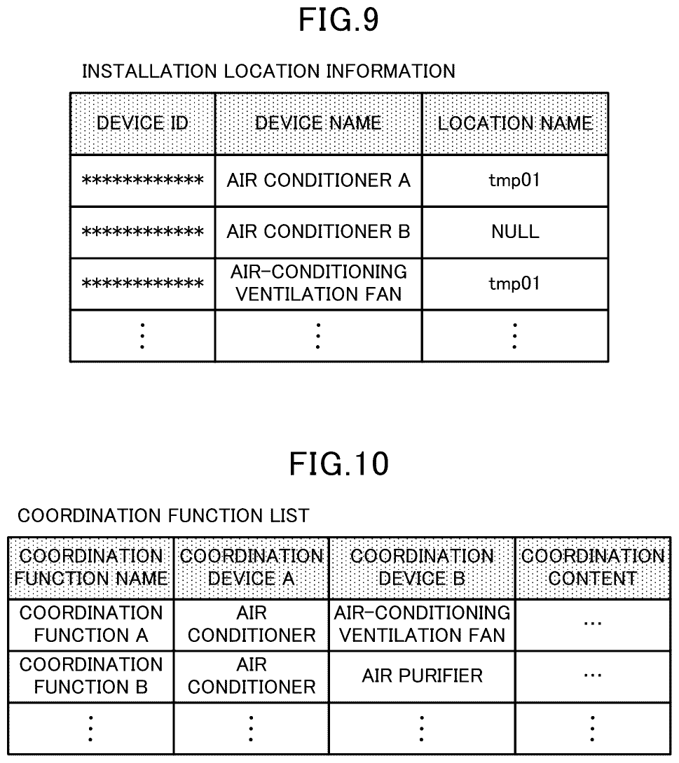

For example, when the data analyzer 202 determines that the air conditioner A and the air-conditioning ventilation fan are installed in the same room and, as illustrated in FIG. 7, LDK (living, dining, kitchen) is previously registered by the user as the installation location of the air conditioner A, the data analyzer 202 stores LDK as the location name of the air-conditioning ventilation fan in the installation location information (see FIG. 8). Also, when the data analyzer 202 determines that the air conditioner A and the air-conditioning ventilation fan are installed in the same room and the installation locations of the air conditioner A and the air-conditioning ventilation fan are both undetermined, the data analyzer 202 stores the same information temporarily generated as each of the locations so as to be able to recognize that the installation locations of the air conditioner A and the air-conditioning ventilation fan are the same (see FIG. 9).

The coordination suggester 203 is an example of coordination suggesting means according to the present disclosure. When there is a coordination function associated with devices 5 (that is, the coordinated operation for the devices 5 are achievable) that are installed in the same installation location, and the coordination setting for the devices 5 has not yet been made, the coordination suggester 203 makes a suggestion to the user about coordination between the devices 5. First, the coordination suggester 203 refers to the installation location information stored in the installation location information storage 243 and detects the devices 5 installed in the same installation location. When the coordination suggester 203 detects the devices 5 installed in the same installation location, the coordination suggester 203 refers to the coordination function list stored in a coordination function list storage 244 and detects the coordination function associated with those devices 5. The coordination function list storage 244 is a memory area provided by the auxiliary storage device 24.

As illustrated in FIG. 10, the coordination function list is a list of a coordination function name, names of coordination devices (coordination devices A and B), and a coordination content that are associated with each other for each coordination function. For example, the coordination function A is a function executable when the air conditioner and the air-conditioning ventilation fan are installed in the same room, and the coordination function B is a function executable when the air conditioner and air purifier are installed in the same room. The coordination function A is, for example, a function for which ventilation air volume of the air-conditioning ventilation fan is adjusted in accordance with the number of occupants detected by a thermal image sensor, such as an infrared thermography provided by the air conditioner. The coordination function B is, for example, a function for which cleanliness factor of the air purifier is adjusted in accordance with the number of occupants detected by the aforementioned thermal image sensor provided by the air conditioner. These functions allow for appropriate reduction of indoor CO₂ concentration.

When the coordination suggester 203 detects the coordination function associated with the devices 5 installed in the same installation location, the coordination suggester 203 refers to the coordinated information stored in a coordinated information storage 245 and determines if the coordination setting for the devices 5 has already been made. The coordinated information storage 245 is a memory area provided by the auxiliary storage device 24. The coordinated information is information on which the device IDs of the devices 5 for which the coordination setting is made are associated with the coordination function.

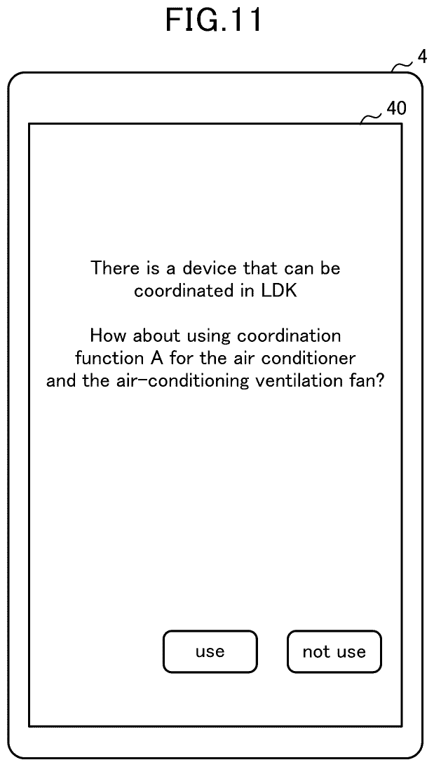

When the coordination setting for the devices 5 has not been made, that is, when there is a coordination function associated with those devices 5 that are installed in the same installation location, and the coordination setting for the devices 5 has not yet been made, the coordination suggester 203 generates information (hereinafter referred to as “coordination suggesting information”) for suggesting the user to use the coordination function, and sends the generated information to the user terminal 4 of the user. The device operation application of the user terminal 4 having received such coordination suggesting information displays the coordination suggesting screen illustrated in FIG. 11 on the display 40 of the user terminal 4.

When the user wants to use the suggested coordination function, the user presses the “use” button shown on the coordination suggesting screen, and when the user does not want to use the suggested coordination function, the user presses the “not use” button shown on the coordination suggesting screen. Upon pressing of the “use” button by the user, the coordination suggester 203 performs coordination setting for the devices 5. Specifically, the coordination suggester 203 updates the coordinated information stored in the coordinated information storage 245 based on the device IDs of the devices 5 and the coordination function. Upon completion of the coordination setting, the server 2 thereafter controls the devices 5 in accordance with the coordination function.

### Coordination Suggesting Processing

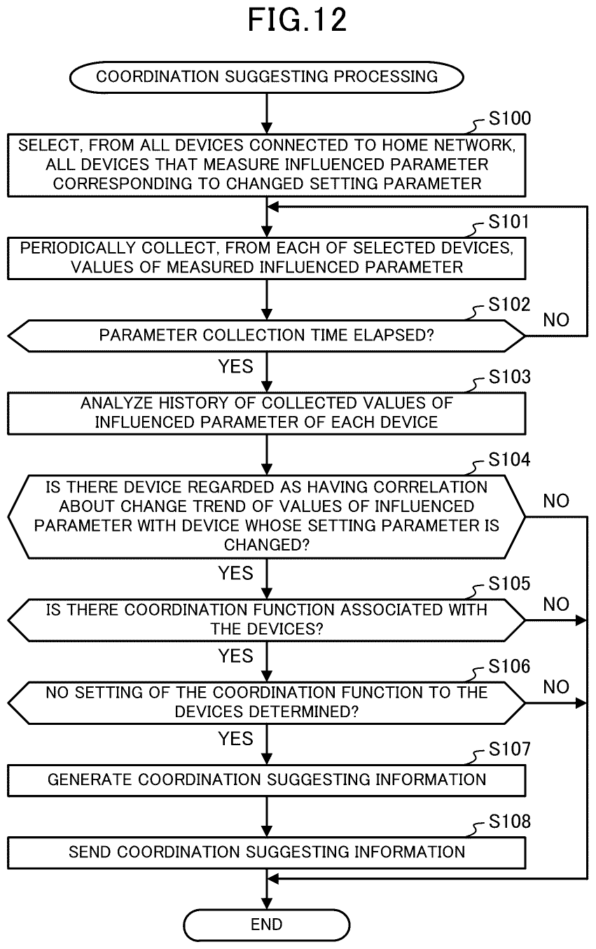

FIG. 12 is a flowchart illustrating steps of the coordination suggesting processing executed by the server 2. Upon reception of the parameter change notification from any of the devices in the house H, the server 2 executes the following coordination suggesting processing.

### Step S100

The server 2 selects, from among all the devices 5 connected to the home network built in the house H, all the devices 5 that measure influenced parameters corresponding to the changed setting parameter indicated by the parameter change notification. Then, the processing by the server 2 proceeds to step S101.

### Step S101

The server 2 periodically collects the values of the measured influenced parameter from each of such selected devices 5. Then, the processing by the server 2 proceeds to step S102.

### Step S102

The server 2 determines whether or not a predetermined parameter collection time has elapsed since start of the collection of the values of the influenced parameter. When the parameter collection time has elapsed (Yes in step S102), the processing by the server 2 proceeds to step S103. When the parameter collection time has not elapsed (No in step S102), the processing by the server 2 returns to step S101.

### Step S103

The server 2 analyzes a history of the collected values of the influenced parameter of each device 5. Then, the processing by the server 2 proceeds to step S104.

### Step S104

The server 2 determines whether there is a device 5 regarded as having a correlation about a change trend of the values of the influenced parameter with a device 5 whose setting parameter is changed. When there is the device 5 regarded as having the correlation about the change trend of the values of the influenced parameter with the device 5 whose setting parameter is changed (Yes in step S104), the processing by the server 2 proceeds to step S105. When there is not a device 5 regarded as having the correlation about the change trend of the values of the influenced parameter with the device 5 whose setting parameter is changed (No in step S104), the server 2 ends the coordination suggesting processing.

### Step S105

The server 2 determines whether or not there is a coordination function associated with the devices 5 (that is, the devices 5 installed in the same installation location) regarded as having a correlation about the change trend of the values of the influenced parameter. When there is the coordination function associated with the devices 5 (Yes in step S105), the processing by the server 2 proceeds to step S106. When there is not a coordination function associated with the devices 5 (No in step S105), the server 2 ends the coordination suggesting processing.

### Step S106

The server 2 determines whether the coordination function has not been set to those devices 5. When no setting of the coordination function to the devices 5 is determined (Yes in step S106), the processing by the server 2 proceeds to step S107. When the coordination function is set to the devices 5 (No in step S106), the server 2 ends the coordination suggesting processing.

### Step S107

The server 2 generates the coordination suggesting information for suggesting the user to use the coordination function. Then, the processing by the server 2 proceeds to step S108.

### Step S108

The server 2 sends the generated coordination suggesting information to the user terminal 4 of the user. Then, the server 2 ends the coordination suggesting processing.

As described above, in the device management system 1 in the present embodiment, when the setting parameter of any of the devices 5 connected to the home network is changed, the server 2 collects, from each of the devices 5 that measure the influenced parameter corresponding to the changed setting parameter among all the devices 5 connected to the home network, values of a measured influenced parameter. The server 2 detects, by analyzing the collected values of the influenced parameter, the device 5 installed in the same room as the device 5 whose setting parameter is changed. Then, when the coordinated operation between the devices 5 is achievable, the server 2 makes a suggestion to the user about the coordination between the devices 5. In this way, providing device coordination services to the user without adding labor to the users can be achieved.

When the server 2 detects the device 5 installed in the same room as the device 5 whose setting parameter is changed, and then the installation location of one of those devices 5 has been registered by the user, the server 2 automatically registers the installation location of another device 5 to be the same as the installation location of the one device 5. Thus, user convenience is enhanced.

### Modified Example 1

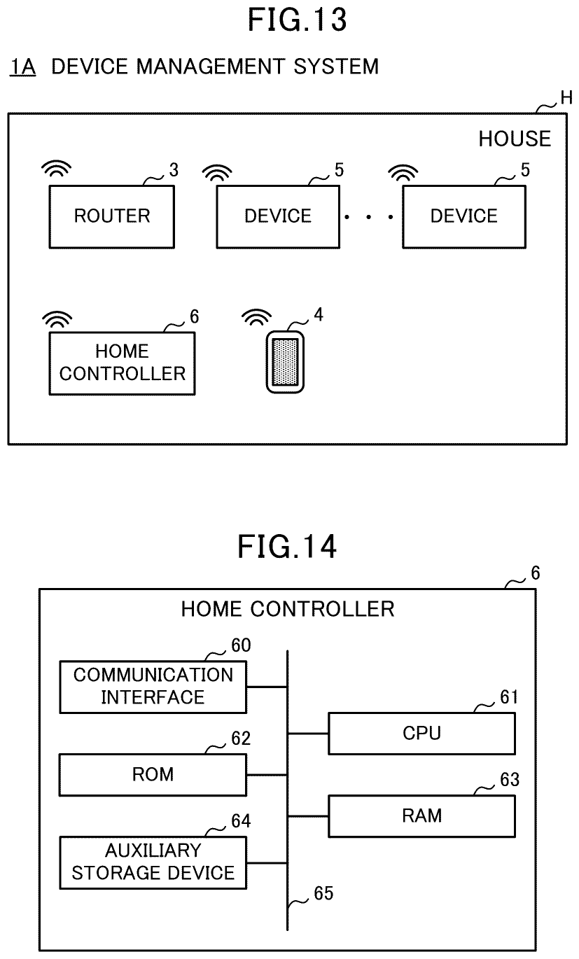

FIG. 13 is a diagram illustrating an overall configuration of a device management system 1A in Modified Example 1 of the embodiment. The device management system 1A is an example of a coordination suggesting system according to the present disclosure. The device management system 1A is a system that enables a user to easily manage one or more devices 5 installed in a house H of the user, similarly to the device management system 1. The device management system 1A includes a router 3, a user terminal 4, and a home controller 6.

### Home Controller 6

The home controller 6 is an example of a coordination suggesting apparatus according to the present disclosure. The home controller 6 is a computer that performs overall control over each device 5 installed in the house H and is, for example, a home energy management system (HEMS) controller.

As illustrated in FIG. 14, the home controller 6 includes, as a hardware configuration, a communication interface 60, a CPU 61, a ROM 62, a RAM 63, and an auxiliary storage device 64. These components are connected to one another via a bus 65. The communication interface 60 is a piece of hardware to communicate with another device through a home network built in the house H. The home network is a network based on, for example, ECHONET Lite (registered trademark).

The CPU 61 performs overall control over the home controller 6. The ROM 62 stores multiple pieces of firmware and data used to execute these pieces of firmware. The RAM 63 is used as a working area for the CPU 61.

The auxiliary storage device 64 includes, for example, a readable and writable non-volatile semiconductor memory or an HDD. The readable and writable non-volatile semiconductor memory is, for example, an EEPROM, a flash memory, or the like. The auxiliary storage device 64 stores a device control program that is a program for controlling each device 5 installed in the house H and data for use in execution of the device control program.

The home controller 6 can obtain, from another server by communication, the device control program or an update program for updating the device control program. These programs can be distributed by storage in a computer-readable recording medium, such as a CD-ROM, a DVD, a magneto-optical disc, a USB memory, an HDD, an SSD, and a memory card. The home controller 6 can also read out and acquire, upon direct or indirect attachment thereto of such recording medium, the device control program or the update program from the recording medium.

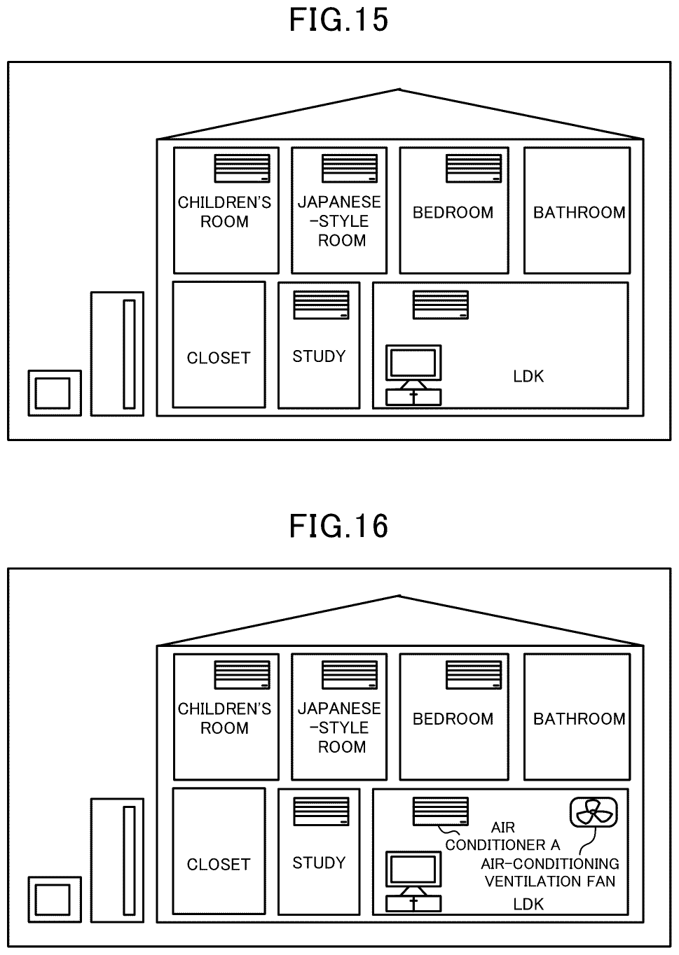

The home controller 6 includes a non-illustrated user I/F provider to suggest to the user a user interface that allows the user to see a relationship between the device 5 in the house H and the installation location. Specifically, the user I/F provider provides the user via the user terminal 4 a user I/F screen displaying an icon of the device 5 on a floor plan of the house H as illustrated in FIG. 15. The user I/F provider is an example of user interface providing means according to the present disclosure. The user can easily confirm the state of the desired device 5 by operating the icon on the user I/F screen and performs a desired operation on the desired device 5.

The home controller 6 includes a functional configuration (see FIG. 4) similar to that of the server 2, and executes the coordination suggesting processing (see FIG. 12) similar to that of the server 2 and executes, on the device 5 on which the coordination setting is made, control based on the set coordination function. In addition, when the home controller 6 detects the device 5 installed in the same room as the device 5 whose setting parameter is changed, and then the installation location of one of those devices 5 has been registered by the user, the home controller 6 automatically registers the installation location of another device 5 to be the same as the installation location of the one device 5, similarly to the server 2, and adds an icon corresponding to the other device 5 to the room on the user I/F screen by the user I/F provider.

For example, when the air-conditioning ventilation fan is detected as the device 5 installed in the same room as the air conditioner A, and LDK is pre-registered as the installation location of the air conditioner A, the user I/F provider newly adds an icon indicating the air-conditioning ventilation fan to LDK on the user I/F screen, as illustrated in FIG. 16.

In this way, the device management system 1A in Modified Example 1 can achieve automatic addition of the icon corresponding to the device 5 on the floor plan on the user I/F screen.

### Modified Example 2

The server 2 may further include a non-illustrated entirety environment stabilizer to control, based on the values of the influenced parameter collected from each device 5, at least any of all the devices 5 connected to the home network to stabilize a home environment in the entire house H. The entirety environment stabilizer is an example of entirety environment stabilizing means according to the present disclosure. For example, when the room temperature of part of the rooms is higher than a predetermined upper limit temperature or lower than a predetermined lower limit temperature, the entirety environment stabilizer executes control to operate all or part of the air conditioners installed in the house H. For example, when the CO₂ concentration of part of the rooms is higher than a predetermined upper limit concentration, the entirety environment stabilizer executes control to operate all the air-conditioning ventilation fan and air purifier installed in the house H.

### Modified Example 3

Not only when the setting parameter of any of the devices 5 is changed, but also when an operation of any of the device 5 is started, the server 2 may detect a device 5 installed in the same room as the device 5 whose operation is started, by collecting from each device 5 the values of the influenced parameter corresponding to the setting parameter at the operation and analyzing the collected values of the influenced parameter.

### Modified Example 4

When installation locations of all the devices 5 connected to the home network in the house H are known or when a certain period elapses since a device 5 is additionally installed in the house H, the server 2 may avoid the execution of the coordination suggesting processing (see FIG. 12). The server 2 may enable/disable the coordination suggesting function in accordance with operation using the device operation application by a user.

### Modified Example 5

When the installation locations of the devices 5 regarded as having a correlation in the change trend of the values of the influenced parameter are previously registered by a user to be different rooms from each other, the server 2 may notify the user via the user terminal 4 that the registered installation locations might be incorrect.

### Modified Example 6

The server 2 may be configured with a plurality of separate servers. In this case, for example, the server 2 may be configured by an influenced parameter collecting server to collect and manage the values of the influenced parameter from each device 5 and a coordination suggesting server to analyze the values of the influenced parameter collected by the influenced parameter collecting server and make a suggestion about the device coordination to a user based on the result of analysis.

### Modified Example 7

All or part of the functional components (see FIG. 4) of the server 2 may be achieved by dedicated hardware. The dedicated hardware is, for example, a single circuit, a composite circuit, a programmed processor, an application specific integrated circuit (ASIC), a field-programmable gate array (FPGA), or a combination thereof.

The technical concepts for the above modified examples may be achieved independently or in combination as appropriate.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The following is a summary of the various aspects of the present disclosure as an appendix.

### (Appendix 1)

A coordination suggesting apparatus, comprising:
influenced parameter collecting means for, when a setting parameter of a first device that is any one of all devices connected to a network built in a building is changed, collecting, from each of devices that measure an influenced parameter among all the devices connected to the network, values of the measured influenced parameter, the influenced parameter being a parameter that is influenced by change of the setting parameter of the first device;
data analysis means for analyzing the collected values of the influenced parameter and detecting a second device regarded as having a correlation with the first device about a change trend of the values of the influenced parameter; and
coordination suggesting means for making a suggestion to a user about coordination between the first device and the second device when the second device is detected and coordinated operation between the first device and the second device is achievable.

### (Appendix 2)

The coordination suggesting apparatus according to Appendix 1, further comprising parameter relationship information storage means for storing parameter relationship information indicating a relationship between the setting parameter and the influenced parameter.

### (Appendix 3)

The coordination suggesting apparatus according to Appendix 1 or 2, wherein after the setting parameter of the first device is changed, the influenced parameter collecting means periodically collects the values of the measured influenced parameter from each of the devices that measure the influenced parameter until a lapse of a predetermined parameter collection time.

### (Appendix 4)

The coordination suggesting apparatus according to any one of Appendixes 1 to 3, further comprising:
installation location information storing means for storing installation location information indicating an installation location of the devices in the building, wherein
when the second device is detected, the data analysis means updates the installation location information such that an installation location of the first device is the same as an installation location of the second device.

### (Appendix 5)

The coordination suggesting apparatus according to Appendix 4, further comprising user interface providing means for providing the user with a user interface that allows the user to see a relationship between the devices in the building and the installation locations.

### (Appendix 6)

The coordination suggesting apparatus according to any one of Appendixes 1 to 5, further comprising entirety environment stabilizing means for stabilizing an environment in the entire building by controlling at least any of the devices connected to the network based on the collected values of the influenced parameter.

### (Appendix 7)

A coordination suggesting system, comprising:
a coordination suggesting apparatus; and
a terminal device, wherein
the coordination suggesting apparatus comprises
   influenced parameter collecting means for, when a setting parameter of a first device that is any one of all devices connected to a network built in a building is changed, collecting, from each of devices that measure an influenced parameter among all the devices connected to the network, values of the measured influenced parameter, the influenced parameter being a parameter that is influenced by change of the setting parameter of the first device;
   data analysis means for analyzing the collected values of the influenced parameter and detecting a second device regarded as having a correlation with the first device about a change trend of the values of the influenced parameter; and
   coordination suggesting means for making a suggestion via the terminal device to a user about coordination between the first device and the second device when the second device is detected and coordinated operation between the first device and the second device is achievable.

### (Appendix 8)

A coordination suggesting method, comprising:
when a setting parameter of a first device that is any one of all devices connected to a network built in a building is changed, collecting, by influenced parameter collecting means, from each of devices that measure an influenced parameter among all the devices connected to the network, values of the measured influenced parameter, the influenced parameter being a parameter that is influenced by change of the setting parameter of the first device;
analyzing, by data analysis means, the collected values of the influenced parameter and detecting a second device considered as having a correlation with the first device about a change trend of the values of the influenced parameter; and
making, by coordination suggesting means, a suggestion to a user about coordination between the first device and the second device when the second device is detected and coordinated operation between the first device and the second device is achievable.

### (Appendix 9)

A program causing a computer to function as:
influenced parameter collecting means for, when a setting parameter of a first device that is any one of all devices connected to a network built in a building is changed, collecting, from each of devices that measure an influenced parameter among all the devices connected to the network, values of the measured influenced parameter, the influenced parameter being a parameter that is influenced by change of the setting parameter of the first device;
data analysis means for analyzing the collected values of the influenced parameter and detecting a second device regarded as having a correlation with the first device about a change trend of the values of the influenced parameter; and
coordination suggesting means for making a suggestion to a user about coordination between the first device and the second device when the second device is detected and coordinated operation between the first device and the second device is achievable.

This application claims the benefit of Japanese Patent Application No. 2022-064358, filed on Apr. 8, 2022, the entire disclosure of which is incorporated by reference herein.

### INDUSTRIAL APPLICABILITY

The present disclosure can be suitable used for a system in which a plurality of devices is connected to a network built in a building.

1. A coordination suggesting apparatus, comprising:
circuitry to
when a setting parameter of a first device that is any one of all devices connected to a network built in a building is changed, collect, from each of devices that measure an influenced parameter among all the devices connected to the network, values of the measured influenced parameter, the influenced parameter being a parameter that is influenced by change of the setting parameter of the first device;
analyze the collected values of the influenced parameter and detect a second device regarded as having a correlation with the first device about a change trend of the values of the influenced parameter; and
make a suggestion to a user about coordination between the first device and the second device when the second device is detected and coordinated operation between the first device and the second device is achievable.

2. The coordination suggesting apparatus according to claim 1, further comprising a parameter relationship information storage store parameter relationship information indicating a relationship between the setting parameter and the influenced parameter.

3. The coordination suggesting apparatus according to claim 1, wherein after the setting parameter of the first device is changed, the circuitry periodically collects the values of the measured influenced parameter from each of the devices that measure the influenced parameter until a lapse of a predetermined parameter collection time.

4. The coordination suggesting apparatus according to claim 1, further comprising:
an installation location information storage to store installation location information indicating an installation location of the devices in the building, wherein
when the second device is detected, the circuitry updates the installation location information such that an installation location of the first device is the same as an installation location of the second device.

5. The coordination suggesting apparatus according to claim 4, wherein the circuitry provides the user with a user interface that allows the user to see a relationship between the devices in the building and the installation locations.

6. The coordination suggesting apparatus according to claim 1, wherein the circuitry stabilizes an environment in the entire building by controlling at least any of the devices connected to the network based on the collected values of the influenced parameter.

7. A coordination suggesting system, comprising:
a coordination suggesting apparatus; and
a terminal device, wherein
the coordination suggesting apparatus comprises circuitry to
when a setting parameter of a first device that is any one of all devices connected to a network built in a building is changed, collect, from each of devices that measure an influenced parameter among all the devices connected to the network, values of the measured influenced parameter, the influenced parameter being a parameter that is influenced by change of the setting parameter of the first device;
analyze the collected values of the influenced parameter and detect a second device regarded as having a correlation with the first device about a change trend of the values of the influenced parameter; and
make a suggestion via the terminal device to a user about coordination between the first device and the second device when the second device is detected and coordinated operation between the first device and the second device is achievable.

8. A coordination suggesting method, comprising:
when a setting parameter of a first device that is any one of all devices connected to a network built in a building is changed, collecting, by an influenced parameter collector, from each of devices that measure an influenced parameter among all the devices connected to the network, values of the measured influenced parameter, the influenced parameter being a parameter that is influenced by change of the setting parameter of the first device;
analyzing, by a data analyzer, the collected values of the influenced parameter and detecting a second device considered as having a correlation with the first device about a change trend of the values of the influenced parameter; and
making, by a coordination suggester, a suggestion to a user about coordination between the first device and the second device when the second device is detected and coordinated operation between the first device and the second device is achievable.

9. A non-transitory computer-readable recording medium storing a program, the program causing a computer to function as:
an influenced parameter collector to, when a setting parameter of a first device that is any one of all devices connected to a network built in a building is changed, collect, from each of devices that measure an influenced parameter among all the devices connected to the network, values of the measured influenced parameter, the influenced parameter being a parameter that is influenced by change of the setting parameter of the first device;
a data analyzer to analyze the collected values of the influenced parameter and detect a second device regarded as having a correlation with the first device about a change trend of the values of the influenced parameter; and
a coordination suggester to make a suggestion to a user about coordination between the first device and the second device when the second device is detected and coordinated operation between the first device and the second device is achievable.

10. The coordination suggesting apparatus according to claim 2, wherein after the setting parameter of the first device is changed, the circuitry periodically collects the values of the measured influenced parameter from each of the devices that measure the influenced parameter until a lapse of a predetermined parameter collection time.

11. The coordination suggesting apparatus according to claim 2, further comprising:
an installation location information storage to store installation location information indicating an installation location of the devices in the building, wherein
when the second device is detected, the circuitry updates the installation location information such that an installation location of the first device is the same as an installation location of the second device.

12. The coordination suggesting apparatus according to claim 3, further comprising:
an installation location information storage to store installation location information indicating an installation location of the devices in the building, wherein
when the second device is detected, the circuitry updates the installation location information such that an installation location of the first device is the same as an installation location of the second device.

13. The coordination suggesting apparatus according to claim 2, wherein the circuitry stabilizes an environment in the entire building by controlling at least any of the devices connected to the network based on the collected values of the influenced parameter.

14. The coordination suggesting apparatus according to claim 3, wherein the circuitry stabilizes an environment in the entire building by controlling at least any of the devices connected to the network based on the collected values of the influenced parameter.

15. The coordination suggesting apparatus according to claim 4, wherein the circuitry stabilizes an environment in the entire building by controlling at least any of the devices connected to the network based on the collected values of the influenced parameter.

16. The coordination suggesting apparatus according to claim 5, wherein the circuitry stabilizes an environment in the entire building by controlling at least any of the devices connected to the network based on the collected values of the influenced parameter.
